(19) United States
(12) Patent Application Publication
(10) Pub. No.: US 2013/0219683 A1
(43) Pub. Date: Aug. 29, 2013

(54) DECORATIVE MICRODUCT CONDUIT

(71) Applicant: David Z. CHEN, Richardson, TX (US)

(72) Inventor: David Z. CHEN, Richardson, TX (US)

(73) Assignee: VERIZON PATENT AND LICENSING INC., Basking Ridge, NJ (US)

(21) Appl. No.: 13/405,964

(22) Filed: Feb. 27, 2012

(51) Int. Cl. G02B 6/44; B25B 27/14; H02G 1/08; H02G 3/08

(52) U.S. Cl. 29/428; 174/481; 385/135; 29/728

(57) ABSTRACT

System and method for inserting cable, such as fiber optic cable, into micro-duct and, simultaneously, installing that micro-duct inconspicuously atop baseboard molding or beneath crown molding against walls inside a building, thereby storing dormant cable in installed micro-duct ready to be pressed into service when the occupant requests that service. Color of the micro-duct is the same as, or blends with, color of the baseboard, or the crown molding to make presence of micro-duct as unobtrusive as possible. A special tool is provided for this purpose allowing one person, acting as solitary installer, to perform the installation without help from other people. Bend elbows are provided to prevent severely short bend radii and, thereby, prevent breakage of glass fibers or deteriorated transmission due to insertion loss. Removable splice cover hides splices. Laser test beam can locate optical fiber breaks.

### BACKGROUND

Fiber-optic cable, containing multiple strands of mutually-isolated optical fibers, offers significant signal-transmission advantages over traditional copper-wire cable, including much greater bandwidth than that available from copper-wire cable. The greater bandwidth permits more channels and greater clarity of picture for TV transmission, faster server-response on the Internet, greater clarity of audio in telephone transmission, faster data rates, etc.

Because fiber-optic cable is being chosen over copper wire cable as customers become more familiar with these advantages, it is advantageous to install fiber optic cable in buildings under construction, such as large multi-dwelling units or condos or apartment buildings that are being built, even if that fiber optic cable is not used immediately upon populating that building with occupants. The issue of where to conveniently store the dormant fiber optic cable, essentially ready to go, until such usage is demanded by each of the occupants is a present challenge. Also, for buildings that were previously constructed, the transition from copper wire cable to fiber-optic cable on a per dwelling unit basis, raises a similar challenge: where should the dormant or unconnected fiber-optic cable be temporarily stored, even if stored for years, where it is unobtrusive, essentially inconspicuous to the buildings' occupants, but where it can easily be pressed into service without inconvenience to the installers or the occupants when they call for such service? Exemplary embodiments, disclosed and claimed herein, successfully address these issues.

### BRIEF DESCRIPTION OF THE DRAWINGS

FIG. 1 is a perspective view of a room in a building showing micro-duct, the micro-duct containing stored communication cable, installed unobtrusively through use of exemplary embodiments;

FIG. 2 is a schematic drawing showing an exemplary side view of a micro-duct embodiment constructed in accordance with an exemplary embodiment;

FIG. 3 is a schematic drawing showing an exemplary side view of another micro-duct embodiment constructed in accordance with an exemplary embodiment;

FIG. 4 is a schematic drawing of the front view of the embodiment shown in FIG. 3 as it might be depicted behind a wall-mounted cable-termination enclosure;

FIG. 5 is a schematic drawing showing a longitudinal view of a shaft with attached pulley used in a hand-tool constructed in accordance with an exemplary embodiment;

FIG. 6 is a schematic drawing showing an end view of the shaft and attached pulley of FIG. 5;

FIG. 7 is a schematic drawing showing a longitudinal view of a handle which attaches to the shaft of FIG. 5, the handle being constructed in accordance with an exemplary embodiment;

FIG. 8 is a schematic drawing showing a longitudinal view of an elbow micro-duct constructed in accordance with an exemplary embodiment; and

FIG. 9 is a schematic drawing of the termination-enclosure of FIG. 4, but with the enclosure's cover removed, thereby exposing the inner-workings of the enclosure.

### DETAILED DESCRIPTION OF PREFERRED EMBODIMENTS

In this description, the same reference numeral in different Figs. refers to the same entity. Otherwise, reference numerals of each Fig. start with the same number as the number of that Fig. For example, FIG. 3 has numerals in the “300” category and FIG. 4 has numerals in the “400” category, etc.

In overview, exemplary embodiments include system and/or methodology for enabling one person, an installer, acting alone with a hand-tool, and without assistance from others, to insert communication cable, such as fiber-optic cable or even copper wire cable, into an uninstalled conduit, such as an uninstalled micro-duct, and simultaneously cause installation of that uninstalled micro-duct in an unobtrusive manner.

The conduit or micro-duct is located inside a building and, more specifically, is located inside a dwelling unit (rented apartment, condominium unit, or other owner-occupied unit) of that building. The installer can completely install that uninstalled conduit, or uninstalled micro-duct, in an unobtrusive, manner against walls inside that dwelling unit, at baseboard molding or crown molding locations, as, or only as, a convenient by-product of using the hand-tool to insert that cable into the conduit or micro-duct. This solitary user action, when applied, e.g., to fiber-optic cable and micro-duct, causes the fiber-optic cable to be inserted and thereafter stored inside the micro-duct inside a building where the micro-duct, if not previously installed, becomes automatically installed as a result of using the hand-tool. The stored fiber-optic cable can subsequently be pressed into service whenever an occupant of that dwelling unit makes the request, even if the request isn't made for years.

In another embodiment, a cable system comprises an uninstalled conduit configured to receive from no more than one person a dormant communication cable into the conduit as the uninstalled conduit becomes installed against a wall inside of a building, solely in response to actions performed by that one person causing the uninstalled conduit to receive the cable. A hand-tool is used by the person to perform these actions. A termination box encapsulates the installed conduit at a slice-location after the installed conduit and the received cable are sliced at the slice location.

In yet another embodiment, a method comprises the inserting of a communication cable into an uninstalled conduit located inside a building. The uninstalled conduit is not affixed to anything, including the walls inside of the building. By performing the inserting of the cable into the conduit against the walls inside of the building, an installed conduit containing the communication cable becomes affixed to the walls, because the conduit has sticky-backed tape along one side of it which sticks to a wall at a chosen location. The installed conduit thereafter contains the communication cable. The foregoing can be achieved by only one person using a hand tool which enabled that person to alone perform the inserting of the communication cable without assistance from another person. The installed conduit is encapsulated at a slice-location after the installed conduit and stored cable are sliced at the slice-location. The slicing may be performed, e.g., for purposes of adding a termination to a particular optical strand in that cable, to communicatively connect that optical strand to equipment located nearby.

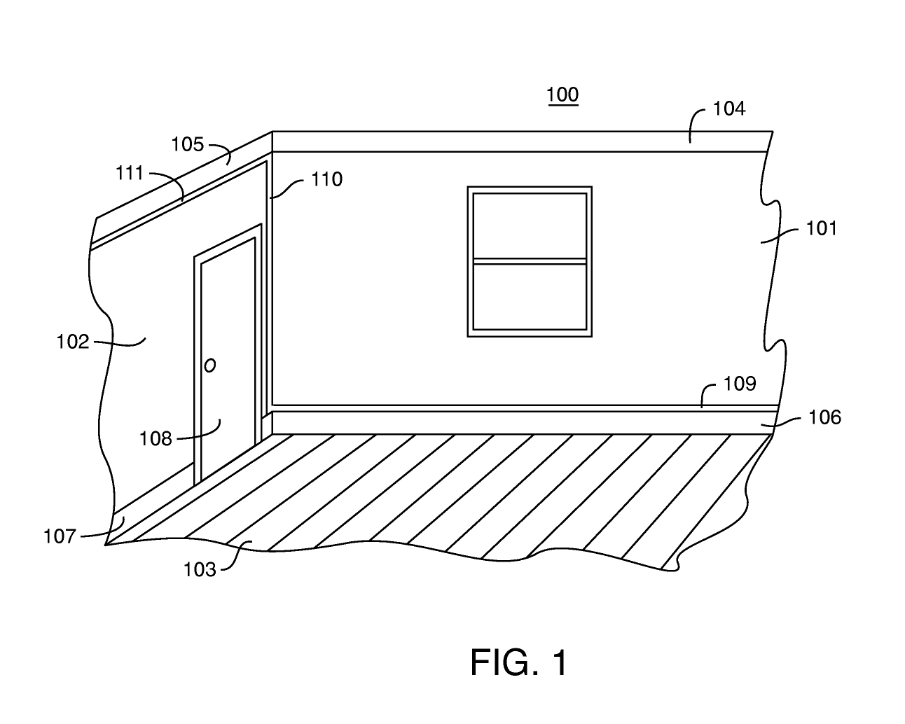

FIG. 1 is a perspective view of room 100 located inside a building in which exemplary embodiments can be employed. Room 100 is defined by at least walls 101 and 102, by two other walls (not shown), by floor 103 and by a ceiling (not shown). Crown moldings 104 and 105 run against the ceiling at the tops of walls 101 and 102, respectively. Baseboard moldings 106 and 107 run against floor 103 at the bottoms of walls 101 and 102, respectively. Door 108 is shown as a passageway through wall 102.

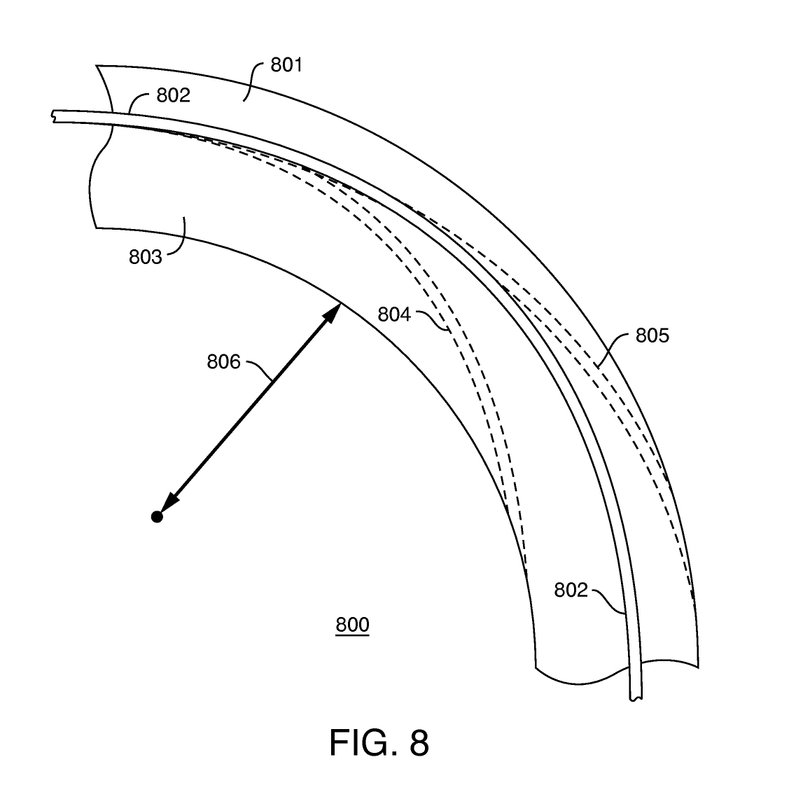

Conduit 109/110/111 is a continuous conduit with three interconnecting sections: section 109 is depicted as inconspicuously installed atop baseboard molding 106 and against wall 101 in a horizontal orientation; conduit section 110 is depicted as inconspicuously installed at the junction of walls 101 and 102 in a vertical orientation; and, conduit section 111 is depicted as inconspicuously installed beneath crown molding 105 and against wall 102 in a horizontal orientation. (Alternatively, the conduit can be installed beneath baseboard molding and above the floor if room has been left for such purposes in new construction, and the conduit can be installed above the crown molding and beneath the ceiling if room has been left for such purposes in new construction.) The transition from horizontal orientation to vertical orientation and vice-versa can be made via interconnecting elbow conduits (not shown in this Fig. and discussed in connection with FIG. 8) to ensure a suitable bend radius for glass optical fibers. If large radii of curvature elbows are not used, resulting damage to, and/or degraded signal transmission through, severely bent glass optical fibers might occur, to be discussed in connection with FIG. 8. Copper wire cables can handle 90° turns usually without adverse conductivity issues because they are not sensitive to bend radius issues, at least not to the same extent as fiber-optic cables.

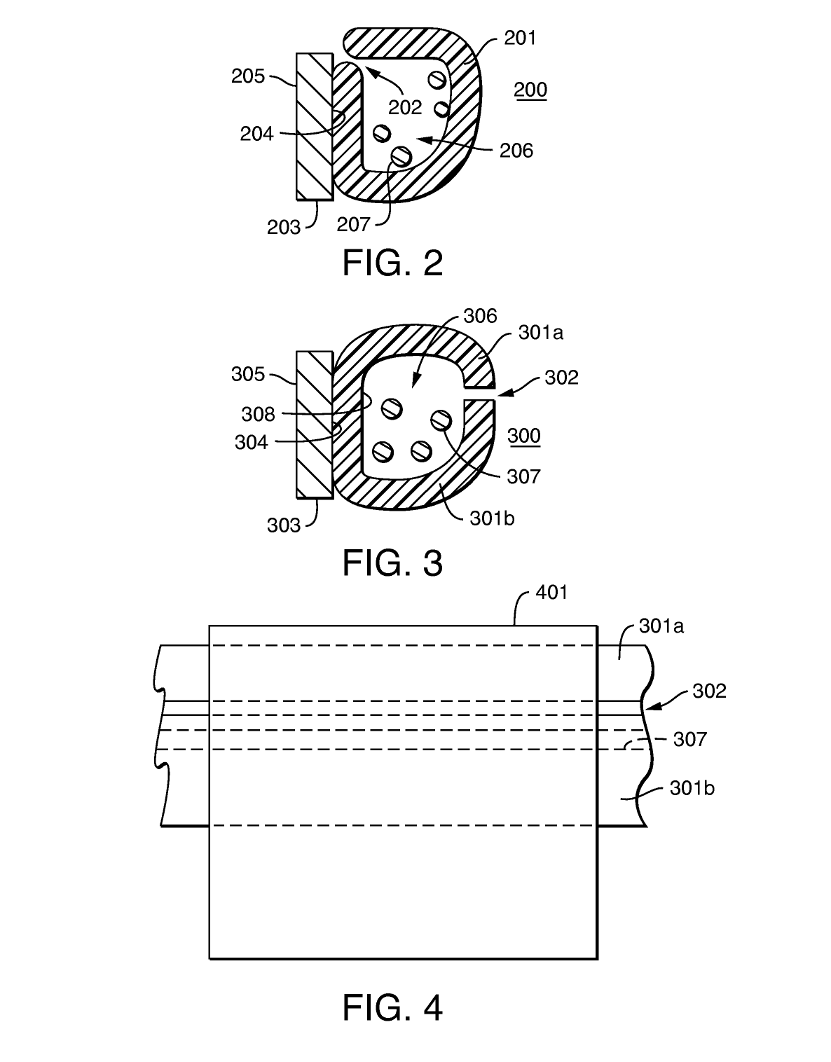

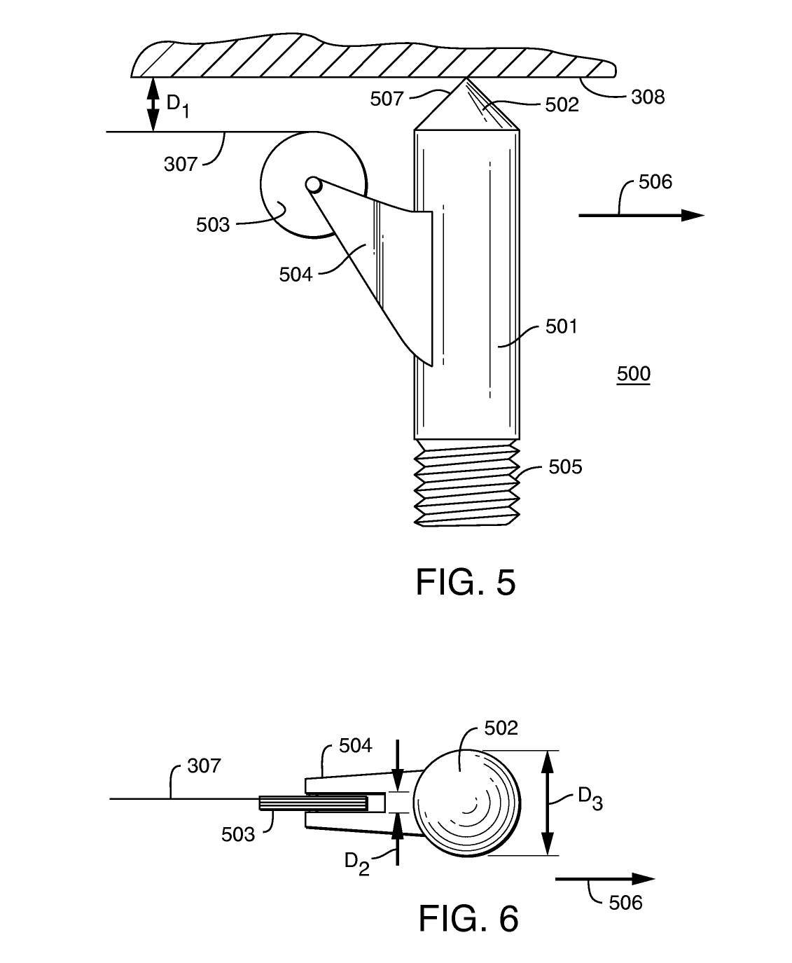

FIG. 2 is a schematic drawing showing an exemplary side view of a micro-duct embodiment 200 constructed in accordance with an exemplary embodiment. Biased micro-duct wall 201 is made from resilient material, such as flexible plastic, which is biased so that it normally tends to close upon itself leaving gap or slit 202 as seen on end in FIG. 2. Slit 202 runs longitudinally for the entire length of micro-duct wall 201. Double sticky back adhesive 203 is made to adhere to flat surface portion 204 of micro-duct wall 201. Flat outside surface 205 of adhesive 203 was also pre-treated with adhesive material so that it can adhere to a wall under an installation controlled by an installer, discussed below in connection with FIGS. 5-7.

Gap or slit 202 is positioned at the top of the micro-duct when affixed to a wall in the position shown. This gap-position may offer the maximum security for mutually insulated copper wire cables 207 or mutually isolated fiber-optic cables 207 (only one cable 207 is labeled although four are depicted) stored in central portion 206 of micro-duct 200, in terms of gravity not being able to pull that cable out of the micro-duct when so oriented. This gap-position may be most suitable for micro-duct that is installed on top of baseboard molding because an upward oriented gap offers easy accessibility to a hand-tool (not shown in this Fig.) used by one person to install the micro-duct. The diameter or span of central portion 206 may be on the order of approximately one centimeter; the diameter of a fiber-optic cable 207 may be on the order of 900 microns.

FIG. 3 is a schematic drawing showing an exemplary side view of another micro-duct embodiment 300 constructed in accordance with an exemplary embodiment. Biased micro-duct walls 301a and 301b are again made from resilient material, such as flexible plastic, which are biased so that they normally tend to close upon themselves at slit 302 located near a mid-point between top and bottom of micro-duct 300, rather than at the top of the micro-duct as in FIG. 2. Slit 302 runs longitudinally for the entire length of micro-duct walls 301a/301b. Double sticky back adhesive 303 is again designed to adhere to flat surface portion 304 of micro-duct wall 301a/301b. Flat outside surface 305 of adhesive 303 was also pre-treated with adhesive material so that it can adhere to a wall under an installation controlled by an installer, discussed below in connection with FIGS. 5-7.

Gap or slit 302 is positioned near the middle of micro-duct when affixed to a wall in the position shown. This orientation may offer sufficient security for copper wire cables or fiber-optic cables 307 (only one cable is labeled although four are depicted) stored in central portion 306 of micro-duct 300, in terms of gravity not being likely to pull that cable out of the micro-duct when so oriented while, simultaneously, offering a convenient location of slit 302 to be accessed by an installer when the micro-duct is located near the ceiling under crown molding 104, possibly some eight feet from the floor. Thus, this orientation may be most suitable for micro-duct that is installed underneath crown molding because a mid-range oriented gap offers accessibility to a hand-tool (not shown in this Fig.) used to install the micro-duct by applying pressure to inside surface 308, to be discussed in detail in connection with FIG. 5. The diameter or span of central portion 306 also may be on the order of approximately one centimeter; the diameter of a fiber-optic cable 307 may be on the order of 900 microns.

FIG. 4 is a schematic drawing of the front view of the embodiment shown in, FIG. 3 as it might be depicted underneath a wall-mounted cable-termination, or splice-junction, esthetic enclosure. Such enclosure may be made from hard plastic, or hard rubber, or fiber glass, or the like and match/complement the décor of the wall against which it is affixed. Micro-duct walls 301a and 301b are shown from a longitudinal viewpoint, slit 302 being depicted as horizontal and slightly higher than midpoint. One cable 307 is shown in dashed hidden line format. If the embodiment of FIG. 4 is utilized when installing cable high on a wall under a crown molding, slit 302 is readily accessible by a hand-tool via an extended handle—to be discussed in connection with FIGS. 5-7 below.

Certain locations along installed micro-duct 300 shall correspond to places where a user may wish to establish a connection to a user device (e.g., telephone, TV, personal computer, etc.) The stored cable in the micro-duct can, therefore, have its external skin slit open in a transverse direction at that location, and the appropriate optical fiber selected from that cable for operative connection to that user device or set of user devices. This can create an unsightly appearance. Accordingly, to maintain an appropriate esthetic sense inside a residence, the place of entry into the micro-duct for the splicing operation or for connectorizing a selected optical fiber strand, should be camouflaged or hidden.

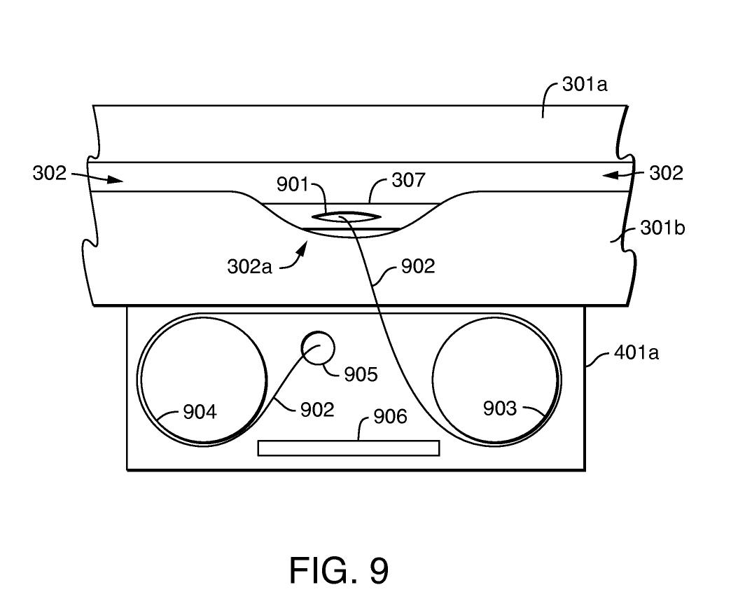

Enclosure 401 may snap-fit over microduct embodiment 300, or be wall-mounted, and hide the results (not shown) of cutting/splicing any of the optical-fiber strands of cable 307 (or of other central portion 306 cables) or, if not spliced, hide mechanical connectors (not shown) attached to ends of those strands. Enclosure 401 is shown in this Fig. with its outer esthetic cover intact, so that microduct walls 301a and 301b hidden by the cover as well as hidden cable 307 are shown in dashed line format. The cover of enclosure 401 can be designed to match, or blend-in with, the microduct exterior or with the motif of the room in which it is wall-mounted, to be as inconspicuous as possible. The functionality of enclosure 401, located behind its cover, is presented below in connection with FIG. 9.

FIG. 5 is a schematic drawing of a longitudinal view of a shaft 501 with attached pulley 503, the shaft attached to a handle (handle not shown in this Fig.) and used as a hand-tool constructed in accordance with an exemplary embodiment. Shaft 501 has a conical or otherwise pointy section 502 at its tip, for penetrating, e.g., slit or gap 302 of resilient micro-duct 300 of FIG. 3. Shaft 501 may be formed together with support structure 504 from hard metal or hard plastic or made separately and permanently connected together. Structure 504 supports rotatable pulley 503 which, in turn, has cable 307 wound around it.

In operation, the cable installer/technician inserts conical tip 502 into gap 302 to spread apart micro-duct walls 301a and 301.b at time of cable storage and micro-duct installation. The apex 507 of tip 502 is inserted into central portion 306 as far as possible, until apex 507 touches inside surface 308, as shown. This degree of penetration into central portion 306 ensures that distance D₁, the distance from inside surface 308 to the exit location of cable 307 from pulley 503, is well within confines of central portion 306. This is necessary to ensure that cable 307, as it unravels from pulley 503 when structure 500 (shaft 501, support arm 504 and pulley 503) are together moved to the right in direction 506, is deployed inside micro-duct 300. Screw threads 505 are attached to the end of shaft 501, opposite pointy end 502, to attach to a handle described below. The installer, acting alone and without help from other people, by pressing against the micro-duct's inside surface 308 while moving structure 500 in direction 506, can deploy cable 307 inside central portion 306 and simultaneously attach sticky-backed surface 305 against wall 101 or 102. This results in insertion/storage of cable in the micro-duct and simultaneous installation of the micro-duct against the wall at a specific location selected by the installer. Alternatively, the sticky-backed surface 305 may be pressed against wall 101 or 102 in a first installation stage, while the micro-duct is empty, and thereafter in a second installation stage, it can be filled with cable 307 via operation of the tool as described above. If done in two stages, the tool pressure can reinforce the previously accomplished sticky-back connection to the wall.

FIG. 6 is a schematic drawing showing an end view of the shaft and attached pulley of FIG. 5, absent inside surface 308. The diameter D₃ of shaft 502 is sufficiently large to cause a sufficient spreading of micro-duct walls 301a/301b so that pulley 503 is not inhibited from rotating by otherwise rubbing against micro-duct walls 301a/301b. Pulley-clearance dimension D₂ is large enough to provide clearance for pulley 503 to freely rotate in support structure 504 when structure 500 is moved by the installer in direction 506. Diameter D₃ may be several times as large as dimension D₂.

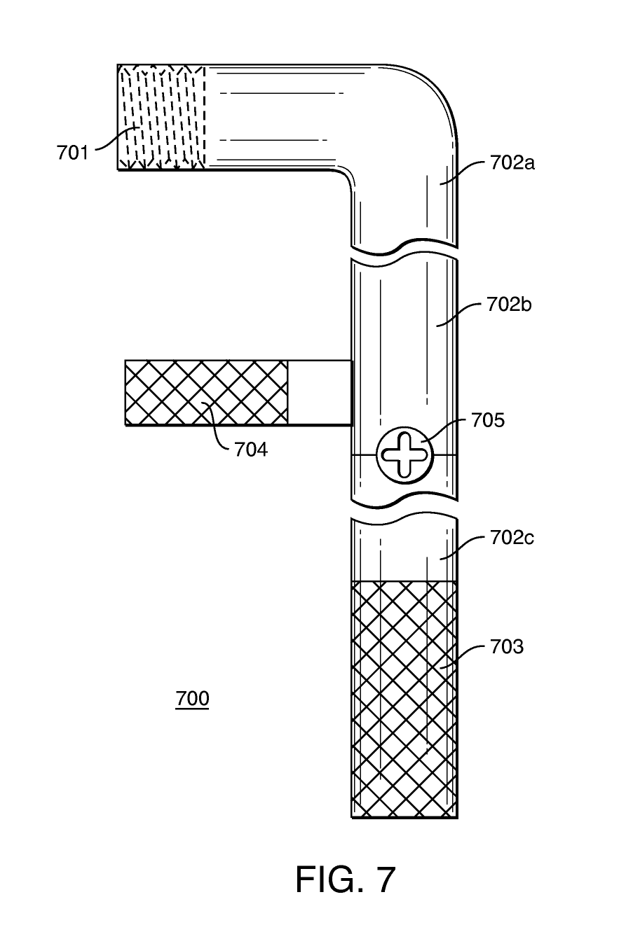

FIG. 7 is a schematic drawing of a longitudinal view of a handle which an installer uses to insert cable into micro-duct and to install that micro-duct while standing on floor 103. The handle attaches to the shaft of FIG. 5, the handle being constructed from metal such as aluminum or from hard and inflexible plastic or fiberglass, in accordance with an exemplary embodiment. Screw-threads 701 mate with screw-threads 505 of FIG. 5 in a tight tolerance, resulting in a snug and secure interconnection. Handle sections 702a, 702b and 702c, shown in broken view to be able to enlarge other handle detail for clarity of presentation, may either be interconnected as one continuous handle or may also be screw-thread (not shown) interconnected similar to how the interconnection is made by screw threads 505/701. In other words, section 702a can screw into section 702b via threads (not shown but similar to threads 505/701). Section 702b can screw into section 702c via threads (not shown but similar to threads 505/701). Handle 700 can, therefore, be easily re-configured to be made longer or shorter by way of different lengths of interconnecting handle sections 702a/702b/702c. These handle sections are provided as part of a hand-tool kit to the installer, along with other tool components, to enable him/her to reach high or low along walls 101 and 102.

Handle section 702a is depicted with a 90° curve to enable the installer holding handle 700 and standing on floor 103 to easily work with the micro-duct embodiment of FIGS. 3 and 4 when inserting cable into that micro-duct and installing that micro-duct at a crown molding location high above the floor. In other words, slit 302, is easily penetrated by pointy-tip 502 when micro-duct 300 is being installed under crown molding such as crown molding 105 shown in FIG. 1, provided that hand tool structure 500 is oriented horizontally when making that penetration. This would be the case when structure 500 is screwed into handle 700 having the 90° bend shown in section 702a.

That 90° orientation can be changed to accommodate other micro-duct gaps and locations. The installer would first unscrew structure 500 from depicted section 702a, and then replace depicted section 702a with a straight handle section (not shown). Finally, the installer would re-screw structure 500 into that straight handle section. This completely straight handle configuration might be better for working with micro-duct that is being installed on top of baseboard molding at floor level. For example, when installing micro-duct 109 against wall 101 along the top of baseboard 106 in FIG. 1, not only is a short, straight handle 700 more comfortable for an installer, but an angle for hand grip 704 other than 90° might be more comfortable for the installer as well. Handle section 702b includes locking mechanism 705 which is hand adjustable and which controls the angle of hand grip 704 relative to orientation of handle section 702b for that purpose. That orientation is depicted as 90° but can be adjusted to other angles as desired by the installer.

Finally, pulley 503 can be detached from support 504 by the installer and a different pulley with a different cable can be inserted instead. A different application may call for a different cable, and the tool is designed to accommodate these different requirements. Thus, a tool kit for the installer can contain at least multiple pulleys (spindles) each containing a different type of communication cable, each attachable to the handle support structure 504, along with both curved and linear sections 702a, along with multiple handle sections of different lengths which can each be screw-connected to its mate to provide the desired overall handle length running from approximately three feet or less to approximately ten feet or more. An easily-modifiable, but sturdy, handle is thus provided for an installer to insert cable into micro-duct and install that micro-duct into a room having virtually any room configuration.

FIG. 8 is a schematic drawing showing a longitudinal view of an elbow micro-duct 800 constructed in accordance with an exemplary embodiment. Micro-duct 800 is constrained to a curved shape having an exemplary single, radius of curvature 806 if a semi-circular curved shape, or having instantaneously-varying radii of curvature (one being exemplary radius of curvature 806) if other than a semi-circular curved shape. The radius is, or the radii are, chosen to be large enough to allow a sufficiently gradual curve of the micro-duct to prevent insertion loss and prevent other signal transmission problems in fiber-optic cable encapsulated by micro-duct 800. Exemplary radius of curvature 806 is depicted shorter in length in FIG. 8 than it otherwise would have been depicted if it were to be geometrically proportionate to the depicted curvature of elbow micro-duct 800; this allows a larger presentation of elbow micro-duct 800 for purposes of clarity of illustration of the micro-duct detail. Elbow micro-ducts are used at junctions, for example, between micro-duct 109 and micro-duct 110 and between micro-duct 110 and micro-duct 111 in FIG. 1. Although use of an elbow would make the installation more noticeable, the elbow, or an equivalent, is necessary to avoid the transmission problems which otherwise might occur.

The elbow has a concave side (the inside curved surface to which radius 806 is measured), a convex side (the opposite curved surface on the outside of the curve) and two neutral sides (midway between the concave side and the convex side on opposite sides of the elbow). Gap 802 is essentially formed in a neutral side of elbow 800, between elbow sections 801 and 803. Gap 804, shown in dashed line only to suggest that it is an alternative embodiment to, and not configured together with, the neutral embodiment of gap 802, represents a gap transition from neutral to concave locations. Oppositely, gap 805, again shown in dashed line only to suggest that it is an alternative embodiment to, and not configured together with, the neutral embodiment of gap 802, represents a gap transition from neutral to convex locations. Elbow embodiments intended to be embraced by the appended claims include: neutral to neutral, concave to neutral and vice versa, convex to neutral and vice versa, concave to convex, concave to concave, and convex to convex.

For example, the neutral to neutral gap 802 embodiment may be useful when installing micro-duct atop floor baseboard and a 90° turn along the baseboard is required. The other embodiments may be useful when transitioning from horizontal to vertical or vice-versa and also transitioning from a prior wall to an abutting wall, for example, when transitioning from micro-ducts 109 to 110 or from micro-ducts 110 to 111.

FIG. 9 is a schematic drawing of termination-enclosure 401 of FIG. 4, but with the enclosure's cover removed, thereby exposing inner workings of the enclosure as well as the back face 401a of enclosure 401. Back face 401a can be attached directly to the wall via screws (not shown) or the like. A first termination enclosure 401, with an appropriate cover color and design, can be used in a common hallway such as a common hallway in a multiple dwelling unit building (e.g., a residential or commercial condominium or apartment building). And, a second termination enclosure 401, with a different appropriate cover color and design, can be used inside an individual residence of that building.

Micro-duct walls 301a and 301b are flexible and are shown separated by gap 302 but with wall 301b pulled downward at location 302a, as if the gap were pried open by a screwdriver or similar tool (not shown), or by the tool of FIG. 5. This exposes fiber-optic cable 307, the exterior skin of which can then be longitudinally slit open with a knife (not shown) leaving slit or opening 901. A particular clad optical fiber 902 can be selected from the group of mutually-isolated optical fibers in cable 307 and removed from the cable.

Assuming the source of the optical transmission in cable 307 is coming from the left hand side of the drawing, extra slack for optical fiber 902 can be pulled out from cable 307 from the right side of slice 901. Optical fiber slack is useful to store, in the event that subsequent maintenance or repairs, such as re-splicing, may need to be performed at this location in the future. Slack of optical fiber 902 is wound around circular storage forms 903 and 904. The radii of these forms are selected to be large enough to not permit severe bend radii and thereby not unduly stress the glass in the glass optical fiber being wound around the forms. A sufficient amount of slack is wound around both forms to handle conceivable future issues related to this optical strand.

Aperture 905 may be pre-formed in the back face of enclosure 401, by drilling through the back face, or by similar means, at the time of its manufacture and prior to installation. The aperture diameter is made large enough to accommodate cable 307 there-through which, therefore, is also large enough to pass an optical strand removed from cable 307. If additional holes are needed, they can be drilled through the back face of enclosure 401 at the installation location at the time of installation. If a particular resident indicates a particular location inside his/her dwelling unit as being optimum for future installation of optical fiber, a hole can be drilled from that resident's choice of location into a common hallway (or vice versa), at either the hallway's baseboard molding or crown molding location. That hallway hole can be hidden by enclosure 401 with suitable outer-cover to match the common hallway wall décor until, and after, such time as optical fiber service is deployed into that resident's dwelling unit. Similarly, the resulting hole in the wall of the residence can also be hidden, but by a different enclosure, or wall termination box, 401 with suitable outer-cover to match the residence's wall décor.

In FIG. 9, strand 902 is shown fed into aperture 905. Also, splice tray 906 is depicted, and is sufficiently large to permit a skilled optical installer/technician to perform mechanical splices between optical fibers, such as between strand 902 and another strand (not shown) or, alternatively, to connectorize both fibers to mate with each other. The splice tray is large enough to hold the splice junction or the connectorized junction. The other strand can be located on the same side of the wall to which wall cover 401 is affixed or can be located on the opposite side of that wall and passed through hole 905. At floor baseboard level, no ladder is needed to access splice tray 906 and perform the mechanical splice. But, at crown molding level (ceiling level), a ladder (not shown) may be needed to access the splice tray and perform the mechanical splice.

Furthermore, the location of enclosure or wall termination box 401 is a convenient location for testing the optical fibers. For example, a test laser in the 600 nanometer range, outputting red color, can be applied to an optical fiber exposed at this location for purposes of locating a fault in that optical fiber someplace behind the micro-duct. Any break or similar flaw in the glass and/or cladding of that fiber should permit leakage of that red laser beam at that break location, and the red light can be detected signifying a fault at that location. If the micro-duct material is either transparent or translucent, as it could be if installed in an environment that is not esthetically sensitive, such as a military or an industrial environment, that red light can be seen by the naked eye by an observer in a room where that micro-duct is installed. But, if the micro-duct material is opaque, as would be expected in a residence, then that red light can be detected by operation of a light detector that is installed in conical tip 502 of the hand tool of FIG. 5. By shining a laser into an optical fiber via its mechanical connector, and then running the hand tool 500 with optical detector included in the tip along the gap 302, any break in that optical fiber can be easily detected. The detector can cause an audible “beep” when leakage light is detected. The multi-function hand tool of FIG. 5 would then have an additional function: (1) during installation: pry open the micro-duct while deploying optical fiber therein and cause the sticky back micro-duct to be affixed to a wall, or wall molding, and (2) during testing: detect breaks, if any, in a fiber that was previously deployed in a micro-duct that was previously installed.

In this specification, various exemplary embodiments have been described with reference to the accompanying drawings. It will, however, be evident that various modifications and changes may be made thereto, and additional embodiments may be implemented, without departing from the broader scope of the invention as set forth in the claims that follow. The invention is thus not to be interpreted as being limited to particular embodiments and the specification and drawings are to be regarded in an illustrative rather than restrictive sense.

What is claimed is:

1. A cable system, comprising:
an uninstalled and empty conduit configured to receive from no more than one person a dormant communication cable into said conduit as, or after, said uninstalled conduit becomes installed against a wall inside of a building at least in response to actions performed by said one person causing said uninstalled conduit to receive said cable.

2. The cable system of claim 1 further comprising:
a hand-tool used by said person to perform said actions.

3. The cable system of claim 2 further comprising:
a termination box to encapsulate said installed conduit at a slice-location after said received cable is sliced at said slice-location.

4. The cable system of claim 3 wherein said installed conduit is further configured to store said cable in said conduit along with other dormant communication cables subsequently received in said conduit, said cable and said other communication cables each remaining dormant unless and until any one or more of said cable and said cables is used for communication purposes by conducting or transmitting signals there-through.

5. The cable system of claim 4 wherein said cable and said cables are all fiber optic cables or are all copper wire cables or are each selected from the group of cables consisting of fiber optic and copper wire cables.

6. The cable system of claim 5 wherein said fiber optic cables each include a plurality of mutually-isolated optical fiber strands.

7. The cable system of claim 6 wherein said conduit is micro-duct having sticky-backed adhesive tape affixed to an exterior portion of said micro-duct in a longitudinal direction in a manner to cause said micro-duct to adhere to said wall of said building responsive to said actions.

8. The cable system of claim 7 wherein said micro-duct is made from resilient material and configured with a longitudinally-directed slit resiliently-biased in a closed configuration while permitting said slit to be pried open at any location along said slit.

9. The cable system of claim 8, wherein said hand-tool comprises:
a shaft having a pointy end for penetrating said slit at a particular said any location, thereby spreading-apart said micro-duct in the vicinity of said particular location; and
a pulley rotatable about an axel, said pulley having support structure fixedly connected between said axel and said shaft near said pointy end, at least a portion of said pulley configured to penetrate said spread-apart micro-duct when said one person performs said actions.

10. The cable system of claim 9, wherein said hand tool further comprises:
a handle, threadably-connected between the other end of said shaft and one end of said handle, said handle configured to be grasped by both hands of said person in an ergonometric manner, said handle being extendible in length to accommodate installation of said micro-duct along the bottom of crown molding affixed to said wall at ceiling level, said installation being made by said person standing at floor level of said wall.

11. The cable system of claim 10, wherein the longitudinal axis of said threadable connection to said shaft is either co-axial with, or orthogonal to, the longitudinal axis of the remainder of said handle.

12. The cable system of claim 9 wherein said actions include:
said person operating said hand tool so that said pointy end penetrates said slit, one of said fiber-optic cables having been wound-around said pulley and configured to unwind and deposit said unwound cable inside said micro-duct as said pointy end and said at least said portion of said pulley are moved by said one person inside said micro-duct in the direction of said longitudinally-directed slit.

13. The cable system of claim 12 further comprising:
a mechanism allowing said pulley with said one fiber-optic cable to be removed from said hand-tool and replaced with a different pulley holding a different fiber-optic cable, without otherwise modifying said hand-tool.

14. The cable system of claim 12 wherein said actions further include:
said person operating said hand tool so that force is applied by said pointy end to an inside wall of said micro-duct in a manner to press said sticky-backed adhesive against said wall, thereby installing said micro-duct against said wall.

15. The cable system of claim 14 wherein said wall includes baseboard molding at floor level and crown molding at ceiling level, said sticky backed adhesive being pressed by said person against said wall along the top of said baseboard molding or along the bottom of said crown molding or along a path between said baseboard molding and said crown molding.

16. The cable system of claim 15 wherein said micro-duct has a color that matches or blends with color of said baseboard or color of said crown molding so that micro-duct, after installation, is not particularly noticeable in its installed position atop said baseboard or beneath said crown molding.

17. The cable system of claim 15 further comprising:
elbow micro-duct, including a longitudinally-directed and curvilinear elbow slit aligned with said longitudinally-directed slit and compatible with imposed room constraints when attached to an end of said micro-duct, said elbow slit employed by said person when installation of said dormant cable is constrained by room configuration to re-locate from atop said baseboard to beneath said crown molding, or vice-versa, or is required to make other sharp turns because of where said wall is located within said room configuration.

18. The cable system of claim 17 wherein a particular pathway of said elbow slit is selected from the group of elbow slit pathways consisting of: neutral to neutral, concave to concave, convex to convex and concave to convex.

19. The cable system of claim 17 wherein radius of curvature of said elbow micro-duct is sufficiently large to avoid insertion loss and/or other transmission problems in said optical fiber strands, said insertion loss and/or said other transmission problems otherwise created in said strands when subjected to severe bending concomitant with a small radius of curvature.

20. A method, comprising:
inserting a communication cable into an uninstalled conduit located inside a building, said uninstalled conduit not affixed to walls of said building, to obtain, by performance of said inserting, an installed conduit affixed to said walls of said building, said installed conduit containing said communication cable.

21. The method of claim 20, further comprising:
using a hand-tool to enable one person to alone perform said inserting without assistance from another person.

22. The method of claim 21, further comprising:
encapsulating, in an inconspicuous manner, said installed conduit at a slice-location after said stored cable is sliced at said slice-location.
